(19) United States
(12) Patent Application Publication
(10) Pub. No.: US 2022/0267914 A1
(43) Pub. Date: Aug. 25, 2022

(54) INTEGRATED DIRECT AIR CAPTURE OF CO2 FOR AQUEOUS ELECTROCHEMICAL REDUCTION OF CO2

(71) Applicant: Prometheus Fuels, Inc, Santa Cruz, CA (US)

(72) Inventors: Robert MCGINNIS, Santa Cruz, CA (US); Marek HERRMANN-NOWOSIELSKI, Wellesley, MA (US)

(21) Appl. No.: 17/317,686

(22) Filed: May 11, 2021

Related U.S. Application Data
(60) Provisional application No. 63/151,303, filed on Feb. 19, 2021.

(51) Int. Cl. C25B 3/26

(52) U.S. Cl. CPC C25B 3/26

(57) ABSTRACT

The present disclosure provides systems and methods for an integrated direct air capture of reactants from the atmosphere for use in an aqueous electrochemical CO₂ reduction process. An integrated method of direct air capture of CO₂ may be used to achieve the cost-effective production of fuels and materials by electrochemical conversion of carbon dioxide.

### CROSS-REFERENCE

This application claims the benefit of U.S. Provisional Application No. 63/151,303, filed Feb. 19, 2021, which application is incorporated herein by reference.

### BACKGROUND

There is an increasing level of carbon-containing compounds, such as carbon monoxide (CO) and carbon dioxide (CO₂), in the atmosphere. Such increase in the level of carbon-containing compounds may be adversely impacting the global temperature, leading to global warming.

### SUMMARY

The present disclosure describes systems and methods for an integrated direct air capture of reactants from the atmosphere for use in an aqueous electrochemical CO₂ reduction process. An integrated method of direct air capture of CO₂ may be used to achieve the cost-effective production of fuels and materials by electrochemical conversion of carbon dioxide.

Recognized herein is an increased need for efficient methods of producing fuels and other chemical commodities from non-petroleum sources and reducing the level of CO₂ in the atmosphere. Electrocatalytic reduction of carbon dioxide into fuels and materials (e.g., building materials) has long been known to be technically feasible, but it has not been economically practical, in part due to the low efficiency of catalysts for the most useful products (like liquid transportation fuels or polymer monomers), but also due to the cost of capturing CO₂ from the atmosphere, separating the reduced carbon materials (for example water miscible products requiring distillation, such as ethanol), and upgrading reduced products into finished end products.

Carbon species that may be produced from the electrochemical reduction (i.e., adding of electrical energy in the form of chemical bonds) of carbon dioxide are many, including carbon monoxide, hydrocarbon gases, alcohols, aldehydes, organic acids, and to a lesser degree longer chain hydrocarbons. Of these, many have a high a potential for conversion to useful products, including transportation fuels and polymers. Methods of capturing CO₂ from the air have included the use of adsorbents brought in contact with the air to capture CO₂, which is present in low concentrations but has relatively high chemical reactivity. Adsorbents have included aqueous hydroxide solutions, solid adsorbents with reactive functional groups, or non-aqueous reactive liquids. In previous cases, the goal has been to produce a pure CO₂ gas stream, which involves a high degree of change in the entropy of the gas. An integrated CO₂ capture process that results in the dissolution of CO₂ into an electrolyte, such as bicarbonate/carbonate solutions, would require much less change in entropy than converting it into a pure gas. This can result in large energy savings. Additionally, by capturing CO₂ into an electrolyte that will be used in an electrochemical CO₂ reduction process, significant reductions in capital equipment and process complexity may be achieved.

In an aspect, provided herein is a method for integrated direct air capture of CO₂ for aqueous electrochemical reduction of CO₂, comprising: (a) contacting input air stream with an electrolyte solution, wherein the input air stream comprises carbon dioxide, to capture at least a subset of the carbon dioxide from the input air stream in the electrolyte solution; and (b) reducing the at least the subset of the carbon dioxide using the electrolyte solution to generate reduced carbon products.

In some embodiments, the capture of the at least the subset of the carbon dioxide comprises absorption or adsorption by the electrolyte solution.

In some embodiments, the input air stream has a carbon dioxide concentration of at most 1000 ppm.

In some embodiments, the input air stream has a carbon dioxide of at most 500 ppm.

In some embodiments, the input air stream has a carbon dioxide of at most 420 ppm.

In some embodiments, the input air stream comprises H₂O, and wherein subsequent to (a), at least a subset of the H₂O is absorbed by the electrolyte solution.

In some embodiments, the method further comprises controlling a temperature or range thereof of the electrolyte to facilitate capture of the H₂O.

In some embodiments, the reducing in (b) occurs in the absence of an independent hydrogen feed to the electrolyte solution.

In some embodiments, the contacting in (a) further comprises subjecting the electrolyte solution to flow from a first electrolyte reservoir to a contactor, wherein the input air stream and the electrolyte solution are contacted at the contactor.

In some embodiments, the method further comprises returning the electrolyte solution to a second electrolyte reservoir.

In some embodiments, the first electrolyte reservoir is different from the second electrolyte reservoir.

In some embodiments, the first electrolyte reservoir is the same from the second electrolyte reservoir.

In some embodiments, the contactor comprises an adsorbent to facilitate adsorption of the at least the subset of the carbon dioxide from the input air stream.

In some embodiments, the adsorbent comprises a solid substrate comprising reactive chemical adsorbents.

In some embodiments, the adsorbent comprises a polystyrene bead functionalized with amines.

In some embodiments, the adsorbent comprises activated or nanostructured carbon materials.

In some embodiments, the activated or nanostructured carbon materials comprise carbon nanotubes (CNTs), Buckminster fullerene, or graphene.

In some embodiments, the contactor comprises one or more members selected from the group consisting of: a membrane contactor, random or structured gas-liquid contacting packing, film fill, splash packing, packed falling film device, cooling tower, fluidized bed, liquid shower in contact with gases, and nanostructured or activated carbon material.

In some embodiments, the contactor comprises a carbon nanotube membrane, wherein a plurality of nanotubes of the carbon nanotube membrane functions as pores and wherein a plurality of openings of the plurality of nanotubes are functionalized with adsorbing functional groups.

In some embodiments, the adsorbing functional groups comprise an amine.

In some embodiments, the method further comprises controlling a pH or range thereof of the electrolyte solution prior to the contacting of the input air stream and the electrolyte solution.

In some embodiments, the controlling comprises adjusting or maintaining a pH range of the electrolyte solution to between 9-15.

In some embodiments, the controlling comprises adjusting or maintaining a pH range of the electrolyte solution to between 7-10.

In some embodiments, the method further comprises controlling a pH or range thereof of the electrolyte solution subsequent to the contacting of the input air stream and the electrolyte solution.

In some embodiments, the controlling comprises adjusting or maintaining a pH range of the electrolyte solution to between 7-10.

In some embodiments, the method further comprises using a pH controlling unit to adjust a pH or range thereof of the electrolyte solution (i) prior to or (ii) subsequent to the contacting of the input air stream and the electrolyte solution.

In some embodiments, the method further comprises using a pH controlling unit to adjust a pH or range thereof of the electrolyte solution (i) prior to and (ii) subsequent to the contacting of the input air stream and the electrolyte solution.

In some embodiments, the pH controlling unit comprises a bipolar membrane stack configured to increase a pH of the electrolyte solution when flowed through the pH controlling unit in a first direction and decrease the pH of the electrolyte solution when flowed through the pH controlling unit in a second direction different from the first direction.

In some embodiments, the pH controlling unit comprises an electrochemical stack configured to reduce the at least the subset of the carbon dioxide and hydrogen while generating oxygen, such that a pH of the electrolyte solution increases when flowed through the pH controlling unit in a first direction and the pH of the electrolyte solution decrease when flowed through the pH controlling unit in a second direction different from the first direction.

In some embodiments, the pH controlling unit comprises an acid and base supplying unit, wherein the acid and base supplying unit is configured to (i) supply an acidic solution to the electrolyte solution subsequent to the contacting of the air stream and the electrolyte solution to decrease a pH or range thereof of the electrolyte solution and (ii) supply a basic solution to the electrolyte solution prior to the contacting of the air stream and the electrolyte solution to increase a pH or range thereof of the electrolyte solution.

In some embodiments, the method further comprises, prior to (a), contacting a first electrolyte solution with a carbon dioxide containing liquid adsorbent to output the electrolyte solution.

In some embodiments, subsequent to (b), the electrolyte solution is contacted with the first electrolyte solution.

In some embodiments, the liquid adsorbent comprises one or more members selected from the group consisting of: an aqueous hydroxide solution, an amine solution, and an ionic liquid.

In some embodiments, the first electrolyte solution the liquid adsorbent is contacted at a bipolar membrane stack containing an anion exchange membrane or a cation exchange membrane stack or both, wherein the bipolar membrane stack or the cation exchange membrane stack is configured to facilitate transport of carbon containing species from the liquid adsorbent to the first electrolyte solution.

In some embodiments, the reducing the at least the subset of the carbon dioxide using the electrolyte solution generates said reduced carbon products.

In some embodiments, the reduced carbon products comprise fuel.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 illustrates a schematic diagram of a method for capturing carbon dioxide, in accordance with embodiments.

FIG. 2 illustrates an additional schematic diagram of a method for capturing carbon dioxide, including a method for pH control, in accordance with embodiments.

FIG. 3 illustrates an additional schematic diagram of a method for capturing carbon dioxide, including two methods for pH control, in accordance with embodiments.

FIG. 4 illustrates an additional schematic diagram of a method for capturing carbon dioxide, including a method for pH control that raises the pH of one input stream and lowers the pH of another input stream, in accordance with embodiments.

FIG. 5 illustrates an additional schematic diagram of a method for capturing carbon dioxide, including two methods for pH control and a separate method of creating acid and base streams, in accordance with embodiments.

FIG. 6 illustrates an additional schematic diagram of a method for capturing carbon dioxide, including a contactor that contains an adsorbent, in accordance with embodiments.

FIG. 7 illustrates an additional schematic diagram of a method for capturing carbon dioxide, including pH controller, a contactor, and a carbon dioxide adsorber, in accordance with embodiments.

FIG. 8 illustrates an additional schematic diagram of a method for capturing carbon dioxide, including a contactor where a carbon dioxide containing adsorbing liquid is contacted with a carbon dioxide containing fluid, in accordance with embodiments.

FIG. 9 illustrates the surface of a carbon nanotube membrane, with tubes acting as pores through an inert material substrate, in accordance with embodiments.

FIG. 10 illustrates a hollow fiber carbon nanotube membrane, in accordance with embodiments.

FIG. 11 illustrates a carbon nanotube pore functionalized with a desired functional group, in accordance with embodiments.

FIG. 12 illustrates a schematic of a computer system as utilized for the present invention, in accordance with embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “C1+” and “C1+compound,” as used herein, generally refer to a compound comprising one or more carbon atoms, e.g., one carbon atom (C1), two carbon atoms (C2), etc. C1+compounds include, without limitation, alkanes (e.g., methane, CH₄), alkenes (e.g., ethylene, C₂H₂), alkynes and aromatics containing two or more carbon atoms. In some cases, C1′+compounds include aldehydes, ketones, esters and carboxylic acids. Examples of C1+compounds include, without limitation, methane, ethane, ethylene, acetylene, propane, propene, butane, butylene, etc.

The term “unit,” as used herein, generally refers to a unit operation, which is a basic operation in a process. Unit operations may involve a physical change or chemical transformation, such as, for example, separation, crystallization, evaporation, filtration, polymerization, isomerization, transformation, and other reactions. A given process may require one or a plurality of unit operations to obtain the desired product(s) from a starting material(s), or feedstock(s).

The term “carbon-containing material,” as used herein, generally refers to any material comprising at least one carbon atom. In some example, a carbon-containing material is carbon monoxide (CO), carbon dioxide (CO₂), or a mixture of CO and CO₂. The carbon-containing material may be a material derived from CO and/or CO₂, such as bicarbonate or bicarbonate ions.

Provided herein are systems, devices, and methods for direct capture of carbon dioxide from air, and processing thereof. The present invention may comprise an integrated CO₂ capture process that results in the dissolution of CO₂ into an electrolyte. An input air stream comprising CO₂ may be drawn into an electrochemical reduction system that converts CO₂ into hydrocarbons.

The present invention may comprise contacting the input air stream with an electrolyte solution, wherein the input air stream comprises carbon dioxide, to capture at least a subset of the carbon dioxide from the input air stream in the electrolyte solution, and reducing the at least the subset of the carbon dioxide using the electrolyte solution to generate reduced carbon products, such as to generate fuel. The described systems may include one or more additional chemical conversion processes that allow the conversion of CO₂-derived reduced carbon products into hydrocarbon fuels or other useful chemical products.

The method may comprise contacting the input air stream with an electrolyte solution, wherein the input air stream comprises carbon dioxide, to capture at least a subset of the carbon dioxide from the input air stream in the electrolyte solution and reducing the at least the subset of the carbon dioxide using the electrolyte solution to generate reduced carbon products, such as fuels or other useful chemical products.

The input air stream may comprise atmospheric air, such as air from an outdoor or indoor environment. The input air stream may comprise ambient air. The input air stream may comprise relatively low carbon dioxide levels. For example, the carbon dioxide concentration in the input air stream may be at most about 2000 parts per million (ppm), 1800 ppm, 1600 ppm, 1400 ppm, 1200 pm, 1000 ppm, 800 ppm, 600 ppm, 400 ppm, or less. The carbon dioxide concentration in the input air stream may be no more than an ambient concentration of CO₂ in outdoor atmospheric air (e.g., 410 ppm). Alternatively, the input air stream may comprise non-atmospheric air. The non-atmospheric air may comprise a carbon dioxide concentration that is at most about 2000 ppm, 1800 ppm, 1600 ppm, 1400 ppm, 1200 pm, 1000 ppm, 800 ppm, 600 ppm, 400 ppm, or less. Alternatively, the input air stream may have a carbon dioxide concentration of more than about 2000 ppm.

The present disclosure provides chemical conversion systems that convert CO₂ to other chemicals via an electrochemical reduction system. The electrochemical reduction system may generate bicarbonate ions via the capture of CO₂ from atmospheric carbon dioxide. In some instances, a CO₂ reduction system may utilize a feed stream comprising carbon dioxide without the need for further purification. In some instances, a CO₂ reduction system may utilize a feed stream comprising CO₂ without the need for additional separation processes that enrich the CO₂ composition of the feed stream. A feed stream to an electrochemical reduction system may comprise carbon dioxide on a molar basis of about 0.01%, 0.02%, 0.03%, 0.04%, 0.05%, 0.06%, 0.07%, 0.08%, 0.09%, 0.1%, 0.2%, 0.5%, 1%, 5%, 10%, 20%, 50%, 90%, 95% or more. A feed stream to an electrochemical reduction system may comprise carbon dioxide on a molar basis of at least about 0.01%, 0.02%, 0.03%, 0.04%, 0.05%, 0.06%, 0.07%, 0.08%, 0.09%, 0.1%, 0.2%, 0.5%, 1%, 5%, 10%, 20%, 50%, 90%, 95% or more. A feed stream to an electrochemical reduction system may comprise carbon dioxide on a molar basis of no more than about 95%, 90%, 50%, 20%, 10%, 5%, 1%, 0.5%, 0.2%, 0.1%, 0.09%, 0.08%, 0.07%, 0.06%, 0.05%, 0.04%, 0.03%, 0.02%, or 0.01% or less.

An electrochemical reduction system may produce reduced carbon products (e.g., hydrocarbons) at a specific rate based upon the available surface area for electrochemical reduction. An electrochemical reduction system may produce reduced carbon products at a rate of about 10 kilograms/meter squared/hour (kg/m²/hr), 20 kg/m²/hr, 30 kg/m²/hr, 40 kg/m²/hr, 50 kg/m²/hr, 60 kg/m²/hr, 70 kg/m²/hr, 80 kg/m²/hr, 90 kg/m²/hr, 100 kg/m²/hr, 150 kg/m²/hr, or about 200 kg/m²/hr. An electrochemical reduction system may produce reduced carbon products at a rate of about 10 kg/m²/hr, 20 kg/m²/hr, 30 kg/m²/hr, 40 kg/m²/hr, 50 kg/m²/hr, 60 kg/m²/hr, 70 kg/m²/hr, 80 kg/m²/hr, 90 kg/m²/hr, 100 kg/m²/hr, 150 kg/m²/hr, or about 200 kg/m²/hr or more. An electrochemical reduction system may produce reduced carbon products at a rate of no more than about 200 kg/m²/hr, 150 kg/m²/hr, 100 kg/m²/hr, 90 kg/m²/hr, 80 kg/m²/hr, 70 kg/m²/hr, 60 kg/m²/hr, 50 kg/m²/hr, 40 kg/m²/hr, 30 kg/m²/hr, 20 kg/m²/hr, or 10 kg/m²/hr or less.

An electrochemical reduction system may have a selectivity for the conversion of CO₂ to one or more chemical species. In some instances, a selectivity may be defined as the percentage of carbon atoms entering a reactor, system, or unit that are captured from the feed stream and converted to a product species. For example, a selectivity of 50% may indicate that 50% of entering CO₂ molecules were converted to a reduced carbon species in a reactor, system or unit. In some instances, a selectivity may be defined as the percentage of carbon atoms entering a reactor, system, or unit that are converted to a chemical species within a particular class, weight range, carbon number range, or other characteristic. For example, a selectivity of 50% C1-C4 may indicate that 50% of entering CO₂ molecules were converted to a C1 to C4 reduced carbon product. A selectivity may be a single-pass selectivity. A single-pass selectivity may be defined as the percentage of carbon atoms entering a reactor, system, or unit that are captured and converted to a reduced carbon product on a single pass through the reactor, system, or unit. A selectivity may be a recycled selectivity. A recycled selectivity may be defined as the percentage of carbon atoms entering a reactor, system, or unit that are converted to a hydrocarbon product on two or more passes through the reactor, system, or unit.

An electrochemical reduction system may have a selectivity of about 10%, 20%, 30%, 40%, 50%, 60%, 70%, 80%, 90%, 95%, or about 99%. An electrochemical reduction system may have a selectivity of at least about 10%, 20%, 30%, 40%, 50%, 60%, 70%, 80%, 90%, 95%, or about 99% or more. An electrochemical reduction system may have a selectivity of no more than 99%, 95%, 90%, 80%, 70%, 60%, 50%, 40%, 30%, 20%, or 10% or less.

An electrochemical reduction system for the conversion of CO₂ into other chemicals may comprise various components that may be necessary for the reduction of CO₂. Components may include cathodes, anodes, contactors, extractors, pumps, vapor-liquid separators, and ion exchange membranes. In some instances, some components may be included or excluded from a chemical reduction system depending upon the preferred embodiment of the device. In some instances, a chemical reduction system may be a single, stand-alone, or fully integrated system that performs all processes in the electrochemical reduction of CO₂. In other instances, an electrochemical reduction system may comprise at least two or more operatively linked unit operations that collectively perform the necessary processes in the electrochemical reduction of CO₂.

An electrochemical reduction system may comprise a housing. The housing may provide various functions to the electrochemical reduction system, including without limitation: securing components (e.g., membranes), physically containing fluids, separating differing fluids within a single unit, retaining temperature or pressure, and/or providing insulation. The housing may comprise any suitable material, including metals, ceramics, refractories, insulations, plastics, and glasses. The housing may comprise one unit of an electrochemical reduction system (e.g., a cathode). The housing may comprise two or more units of an electrochemical reduction system (e.g., a cathode and anode). A complete electrochemical reduction system may be contained within a single housing.

The housing may include one or more walls. The housing may include one or more compartments. The housing may have a cross-section that is circular, triangular, square, rectangular, pentagonal, hexagonal, or partial shapes or combinations of shapes thereof. The housing may be single-piece or formed of multiple pieces (e.g., pieces welded together). The housing may include a coating on an interior portion thereof. Such coating may prevent reaction with a surface in the interior portion of the housing, such as corrosion or an oxidation/reduction reaction with the surface.

An electrochemical reduction system may comprise a cathode, an anode and an electrolyte solution that collectively provide the necessary components for the reduction of carbon dioxide to other chemical species. The electrolyte solution may comprise an aqueous salt solution that is composed with an optimal ionic strength and pH for the electrochemical reduction of CO₂. An electrolyte solution may comprise an aqueous salt solution comprising bicarbonate ions. In some instances, an electrolyte solution may comprise an aqueous solution of sodium bicarbonate or potassium bicarbonate. In some instances, bicarbonate ions may dissociate in the presence of one or more catalysts to produce CO₂ molecules for a reduction reaction. The dissolution of CO₂ into the electrolyte solution may regenerate or maintain the optimal concentration of bicarbonate ions. The electrolyte solution may comprise an aqueous species comprising carbonate ions. The electrolyte solution may comprise an aqueous species comprising formate ions. The electrochemical conversion of bicarbonate to reduced carbon products may produce hydroxide ions, which can shift a portion of the remaining bicarbonate ions into carbonate ions. Absorption of CO₂ may shift the carbonate ions back to bicarbonate ions. Reduced organic salts such as formate or acetate may be further reduced into desired reduced carbon products.

An electrolyte solution may comprise a solution with a particular ionic strength or molarity. An electrolyte may have an ionic strength of about 0.01 moles/liter (M), 0.05M, 0.1M, 0.2M, 0.3M, 0.4M, 0.5M, 0.6M, 0.7M, 0.8M, 0.9M, 1.0M, 1.1M, 1.2M, 1.3M, 1.4M, 1.5M, 2.0M, 2.5M, or about 3.0M. An electrolyte solution may have an ionic strength of at least about 0.01M, 0.05M, 0.1M, 0.2M, 0.3M, 0.4M, 0.5M, 0.6M, 0.7M, 0.8M, 0.9M, 1.0M, 1.1M, 1.2M, 1.3M, 1.4M, 1.5M, 2.0M, 2.5M, or at least about 3.0M or more. An electrolyte solution may have an ionic strength of no more than about 3.0M, 2.5M 2.0M, 1.5M, 1.4M, 1.3M, 1.2M, 1.1M, 1.0M, 0.9M, 0.8M, 0.7M, 0.6M, 0.5M, 0.4M, 0.3M, 0.2M, 0.1M, 0.05M, or no more than about 0.01M or less. A salt in an electrolyte solution may have a molarity of about 0.01 moles/liter (M), 0.05M, 0.1M, 0.2M, 0.3M, 0.4M, 0.5M, 0.6M, 0.7M, 0.8M, 0.9M, 1.0M, 1.1M, 1.2M, 1.3M, 1.4M, 1.5M, 2.0M, 2.5M, or about 3.0M. A salt in an electrolyte solution may have a molarity of at least about 0.01M, 0.05M, 0.1M, 0.2M, 0.3M, 0.4M, 0.5M, 0.6M, 0.7M, 0.8M, 0.9M, 1.0M, 1.1M, 1.2M, 1.3M, 1.4M, 1.5M, 2.0M, 2.5M, or at least about 3.0M or more. A salt in an electrolyte solution may have a molarity of no more than about 3.0M, 2.5M 2.0M, 1.5M, 1.4M, 1.3M, 1.2M, 1.1M, 1.0M, 0.9M, 0.8M, 0.7M, 0.6M, 0.5M, 0.4M, 0.3M, 0.2M, 0.1M, 0.05M, or no more than about 0.01M or less. A salt in an electrolyte solution may have a molarity in a range from about 0.01M to about 0.1M, about 0.01M to about 0.2M, about 0.01M to about 0.5M, about 0.01M to about 1.0M, about 0.01M to about 3.0M, about 0.1M to about 0.2M, about 0.1M to about 0.5M, about 0.1M to about 1.0M, about 0.1M to about 3.0M, about 0.2M to about 0.5M, about 0.2M to about 1.0M, about 0.2M to about 3.0M, about 0.25 M to about 0.5 M, about 0.25 M to about 1 M, about 0.25 M to about 3 M, about 0.5M to about 1.0M, about 0.5M to about 3.0M, or about 1.0M to about 3.0M.

An electrolyte solution may have an optimal pH for the electrochemical reduction of CO₂. An electrolyte may have a pH of about 0, 1, 2, 3, 4, 5, 6, 7, 8, 9, 10, 11, 12, 13, or about 14. An electrolyte may have a pH of at least about 0, 1, 2, 3, 4, 5, 6, 7, 8, 9, 10, 11, 12, 13, 14 or more. An electrolyte solution may have a pH of no more than about 14, 13, 12, 11, 10, 9, 8, 7, 6, 5, 4, 3, 2, 1, 0 or less. An electrolyte solution may have a pH in a range from about 0 to about 2, about 0 to about 3, about 0 to about 4, about 0 to about 5, about 0 to about 7, about 0 to about 10, about 0 to about 14, about 2 to about 3, about 2 to about 4, about 2 to about 5, about 2 to about 7, about 2 to about 10, about 2 to about 14, about 3 to about 4, about 3 to about 5, about 3 to about 7, about 3 to about 10, about 3 to about 14, about 4 to about 5, about 4 to about 7, about 4 to about 10, about 4 to about 14, about 5 to about 7, about 5 to about 10, about 5 to about 14, about 7 to about 10, about 7 to about 14, or from about 10 to about 14.

An electrolyte solution in an electrochemical reduction system may be a non-aqueous electrolyte solution. In some instances, an electrolyte solution may comprise an ionic liquid with a dissolved salt. An ionic liquid may include, but is not limited to, midazolium-based fluorinated anion ionic liquids, midazolium acetates, midazolium fluoroacetates, pyrrolidinium ionic liquids, or any combination thereof.

Described herein are various chemical products and reaction mixtures generated via the electrochemical reduction of carbon dioxide captured from an input air stream. Electrochemical reduction comprises the addition of electrical energy in the form of chemical bonds. The electrochemical reduction may produce carbon species comprising of one or more members selected from the group consisting of carbon monoxide, hydrocarbon gases, alkanes, alkenes, alcohols, aldehydes, organic acids, and other organic molecules of varying chain lengths. The products of the described electrochemical reduction systems may be further processed into useful products, including transportation fuels and polymers.

Described herein are various chemical products and reaction mixtures generated via the electrochemical reduction of CO₂ derived from a gas source. The gas source may be the atmosphere. The gas source may be any CO₂-bearing gas stream. Chemical products may include any process stream that is exported from a chemical processing system or any process stream that undergoes no further reactive processes. A reaction mixture may include any process mixture, reagent, or compound within the confines of a chemical reactor, reactor system, or in a process stream between chemical reactors or reactor systems. The chemical products and reaction mixtures of the present invention may include organic molecules where one or more of the constituent carbon atoms are derived from CO₂. In some instances, a chemical product or reaction mixture may contain only carbon atoms derived from CO₂. In other instances, a chemical product may contain carbon atoms derived from CO₂ and carbon atoms derived from other sources (e.g. bio fuels). In some instances, chemical products of the present invention may have a distinct carbon isotope signature that is consistent with the carbon isotope signature of CO₂ derived from the atmosphere. In some instances, chemical products and reaction mixtures of the present invention may have a distinct carbon isotope signature that is consistent with the carbon isotope signature of CO₂ derived from a non-atmospheric source such as the combustion of fossil fuels. The carbon isotope signature of a chemical product or reaction mixture may be measured by an isotopic ratio of ¹⁴C:¹²C or ¹³C:¹²C. In some instances, the isotopic signature of a chemical product or reaction mixture may be measured as a percent difference between the natural isotopic ratio of carbon and the measured isotopic ratio. A percent difference between the natural isotopic ratio of carbon and the measured isotopic ratio for ¹⁴C, Δ¹⁴C, may be calculated as:

$${Δ}^{14} C = [ \frac{{[ \frac{{}^{14} C}{{}^{12} C} ]}_{measured}}{{[ \frac{{}^{14} C}{{}^{12} C} ]}_{standard}} - 1 ] \times 1000 \% {Δ}^{14} C = [ \frac{{[ \frac{{}^{14} C}{{}^{12} C} ]}_{measured}}{{[ \frac{{}^{14} C}{{}^{12} C} ]}_{standard}} - 1 ] \times 1000 \%$$

A percent difference between the natural isotopic ratio of carbon and the measured isotopic ratio for ¹³C, Δ¹³C, may be calculated as:

$${Δ}^{13} C = [ \frac{{[ \frac{{}^{13} C}{{}^{12} C} ]}_{measured}}{{[ \frac{{}^{13} C}{{}^{12} C} ]}_{standard}} - 1 ] \times 1000 \% \\ {Δ}^{13} C = [ \frac{{[ \frac{{}^{13} C}{{}^{12} C} ]}_{measured}}{{[ \frac{{}^{13} C}{{}^{12} C} ]}_{standard}} - 1 ] \times 1000 \%$$

A chemical product or reaction mixture may have a Δ¹⁴C of about −100%, —10%, 0%, 5%, 10%, 20%, 30%, 40%, 45%, 50% or about 100%. A chemical product or reaction mixture may have a Δ¹³C of about −40%, −35%, −30%, −28%, −26%, −24%, −22%, −20%, −15%, −10%, −8%, or about −5%.

A chemical product or reaction mixture of the present invention may include gaseous, liquid, or solid substances. Chemical products and reaction mixtures of the current invention may include one or more organic compounds. Chemical products and reaction mixtures may be miscible or immiscible in water. Chemical products and reaction mixtures may be polar or nonpolar. Chemical products and reaction mixtures may be acidic, basic, or neutral. Organic compounds may include alkanes, alkenes, alkynes, cycloalkanes, cycloalkenes, cycloalkynes, substituted alkanes, substituted alkenes, substituted alkynes, alcohols, esters, carboxylic acids, ethers, amines, amides, aromatics, heteroaromatics, sulfides, sulfones, sulfates, thiols, aldehydes, ketones, amides, and halogenated compounds. Chemical products and reaction mixtures may include branched or linear compounds. Chemical products and reaction mixtures may comprise oxygen, methane, ethane, ethylene, propane, butane, hexanes, octanes, decanes, carbon monoxide, methanol, ethanol, propanol, butanol, hexanol, octanol, and formate. Chemical products and reaction mixtures may include organometallic compounds. Chemical products and reaction mixtures of the present disclosure may include compounds intended for consumer use or industrial use, such as fuels, solvents, additives, polymers, food additives, food supplements, pharmaceuticals, fertilizers, agricultural chemicals, coatings, lubricants, and building materials. Chemical products and reaction mixtures of the present disclosure may comprise a precursor, component, substituent, or substrate for a product produced by further processing.

An organic compound of the present disclosure may comprise one or more carbon atoms. In some instances, an organic compound may comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 carbon atoms. In some instances, an organic compound may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 or more carbon atoms. In some instances, an organic compound may comprise no more than about 70, 65, 60, 55, 50, 45, 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2 or less carbon atoms. An organic compound of the present disclosure may comprise one or more carbon atoms derived from CO or CO₂. In some instances, an organic compound may comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 carbon atoms that are derived from CO or CO₂. In some instances, an organic compound may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or about 70 or more carbon atoms that are derived from CO or CO₂. In some instances, an organic compound may comprise no more than about 70, 65, 60, 55, 50, 45, 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2 or less carbon atoms that are derived from CO or CO₂.

A chemical product or reaction mixture of the present disclosure may comprise more than one chemical species. A chemical product or reaction mixture may be a mixture of about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95 or about 100 detectable chemical compounds. A chemical product or reaction mixture may be a mixture of at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95 or about 100 or more detectable chemical compounds. A chemical product or reaction mixture may be a mixture of no more than about 100, 95, 90, 85, 80, 75, 70, 65, 60, 55, 50, 45, 40, 35, 30, 29, 28, 27, 26, 25, 24, 23, 22, 21, 20, 19, 18, 17, 16, 15, 14, 13, 12, 11, 10, 9, 8, 7, 6, 5, 4, or no more than about 3 or less detectable chemical compounds.

A chemical product or reaction mixture of the present disclosure may comprise a particular compound at a particular weight percentage or molar percentage of the total chemical product or reaction mixture. For example, a particular chemical product may include at least about 50 wt % ethanol. In another example, a particular chemical product may include no more than about 1 wt % water. In some instances, at least about 10%, 15%, 20%, 25%, 30%, 35%, 40%, 45%, 50%, 55%, 60%, 65%, 70%, 75%, 80%, 85%, 90%, 95%, 96%, 97%, 98%, 99% or more of a chemical product or reaction mixture may be a specific chemical compound on a weight or molar basis. In some instances, no more than about 99%, 98%, 97%, 96%, 95%, 90%, 85%, 80%, 75%, 70%, 65%, 60%, 55%, 50%, 45%, 40%, 35%, 30%, 25%, 20%, 15%, or no more than about 10% or less of a chemical product or reaction mixture be a specific chemical compound on a weight or molar basis.

A chemical product or reaction mixture of the present disclosure may include compounds within a particular range of molecular weights or carbon numbers. In some instances, at least about 10%, 15%, 20%, 25%, 30%, 35%, 40%, 45%, 50%, 55%, 60%, 65%, 70%, 75%, 80%, 85%, 90%, 95%, 96%, 97%, 98%, 99% or more of a chemical product or reaction mixture may include compounds within a particular molecular weight range or carbon number range. In some instances, no more than about 99%, 98%, 97%, 96%, 95%, 90%, 85%, 80%, 75%, 70%, 65%, 60%, 55%, 50%, 45%, 40%, 35%, 30%, 25%, 20%, 15%, or no more than about 10% or less of a chemical product or reaction mixture may include compounds within a particular molecular weight range or carbon number range. A chemical product or reaction mixture may include compounds within a molecular weight range from about 15 g/mol to about 30 g/mol, about 15 g/mol to about 60 g/mol, about 15 g/mol to about 100 g/mol, about 15 g/mol to about 200 g/mol, about 15 g/mol to about 400 g/mol, about 15 g/mol to about 600 g/mol, about 15 g/mol to about 1000 g/mol, about 30 g/mol to about 60 g/mol, about 30 g/mol to about 100 g/mol, about 30 g/mol to about 200 g/mol, about 30 g/mol to about 400 g/mol, about 30 g/mol to about 600 g/mol, about 30 g/mol to about 1000 g/mol, about 60 g/mol to about 100 g/mol, about 60 g/mol to about 200 g/mol, about 60 g/mol to about 400 g/mol, about 60 g/mol to about 600 g/mol, about 60 g/mol to about 1000 g/mol, about 100 g/mol to about 200 g/mol, about 100 g/mol to about 400 g/mol, about 100 g/mol to about 600 g/mol, about 100 g/mol to about 1000 g/mol, about 200 g/mol to about 400 g/mol, about 200 g/mol to about 600 g/mol, about 200 g/mol to about 1000 g/mol, about 400 g/mol to about 600 g/mol, about 30 g/mol to about 1000 g/mol, about 30 g/mol to about 100 g/mol, about 30 g/mol to about 200 g/mol, about 30 g/mol to about 400 g/mol, about 30 g/mol to about 600 g/mol, about 400 g/mol to about 1000 g/mol, or about 600 g/mol to about 1000 g/mol. A chemical product or reaction mixture may include compounds within a carbon number range from about C1 to about C2, about C1 to about C3, about C1 to about C4, about C1 to about C5, about C1 to about C6, about C1 to about C8, about C1 to about C10, about C1 to about C20, about C1 to about C30, about C1 to about C40, about C2 to about C3, about C2 to about C4, about C2 to about C5, about C2 to about C6, about C2 to about C8, about C2 to about C10, about C2 to about C20, about C2 to about C30, about C2 to about C40, about C3 to about C4, about C3 to about C5, about C3 to about C6, about C3 to about C8, about C3 to about C10, about C3 to about C20, about C3 to about C30, about C3 to about C40, about C4 to about C5, about C4 to about C6, about C4 to about C8, about C4 to about C10, about C4 to about C20, about C4 to about C30, about C4 to about C40, about C5 to about C6, about C5 to about C8, about C5 to about C10, about C5 to about C20, about C5 to about C30, about C5 to about C40, about C6 to about C8, about C6 to about C10, about C6 to about C20, about C6 to about C30, about C6 to about C40, about C8 to about C10, about C8 to about C20, about C8 to about C30, about C8 to about C40, about C10 to about C20, about C10 to about C30, about C10 to about C40, about C20 to about C30, about C20 to about C40, or about C30 to about C40.

A chemical product or reaction mixture of the present disclosure may comprise one or more impurities. Impurities may derive from reactant streams, reactor contaminants, breakdown or decomposition products of produced organic compounds, catalyst compounds, or side reactions in the electrochemical reduction system or other chemical conversion systems described herein. A chemical product or reaction mixture may comprise one or more organic impurities such as formate or higher molecular weight alcohols. A chemical product or reaction mixture may include carbon or non-carbon nanomaterial impurities. A chemical product or reaction mixture may comprise one or more inorganic impurities derived from sources such as catalyst degradation or leaching and corrosion of processing equipment. An inorganic impurity may comprise sodium, magnesium, potassium, calcium, titanium, vanadium, chromium, manganese, iron, cobalt, nickel, copper, zinc, aluminum, silicon, yttrium, zirconium, niobium, molybdenum, ruthenium, rhodium, palladium, silver, cadmium, indium, tin, antimony, tantalum, tungsten, osmium, platinum, gold, mercury, and lead. Inorganic impurities may be present in oxidized or reduced oxidation states. Inorganic impurities may be present in the form of organometallic complexes. An impurity in a chemical product or reaction mixture may be detectable by any common analysis technique such as gas or liquid chromatography, mass spectrometry, IR or UV-Vis spectroscopy, Raman spectroscopy, X-ray photoelectron spectroscopy, X-ray diffraction, or other methods. One or more impurities may be detectable at an amount of at least about 1 part per billion (ppb), 5 ppb, 10 ppb, 50 ppb, 100 ppb, 250 ppb, 500 ppb, 750 ppb, 1 part per million (ppm), 5 ppm, 10 ppm, 50 ppm, 100 ppm or more. One or more impurities may be detectable at an amount of no more than about 100 ppm, 50 ppm, 10 ppm, 5 ppm, 1 ppm, 750 ppb, 500 ppb, 250 ppb, 100 ppb, 50 ppb, 10 ppb, 5 ppb, or no more than about 1 ppb or less.

A chemical product may have a particular level of purity. In some instances, a chemical product may have sufficient purity to achieve a particular grade or standard. A chemical product may be ACS grade, reagent grade, USP grade, NF grade, laboratory grade, purified grade or technical grade. A chemical product may have a purity that exceeds an azeotropic composition, e.g. >95% ethanol. A gaseous chemical product of the current invention may have a purity rating of about N1.0, N2.0, N3.0, N4.0, N5.0, N6.0 or greater. A chemical product may achieve a purity level according to a defined international standard. E.g. the ASTM D-1152/97 standard for methanol purity.

In some instances, a chemical product or reaction mixture from an electrochemical reduction system may have no detectable amount of certain impurities. In some instances, a chemical product or reaction mixture may have no detectable amount of biological molecules or derivatives thereof. A chemical product or reaction mixture may contain no detectable amount of lipids, saccharides, proteins, nucleic acids, amino acids, spores, bacteria, viruses, protozoa, fungi, animal or plant cells, or any component thereof.

An input air stream may come into contact with an electrolyte solution. This contact may be facilitated by a contactor. An electrochemical reduction system may comprise one or more contactor units. A contactor may comprise any unit operation or separation unit that selectively separates one or more chemical species from a feed stream. In some instances, a contactor may comprise a gas adsorption column. In other instances, a contactor may comprise packing to increase a liquid solutions surface area and a fan to increase gas passage at the liquid interface. In other instances, a contactor may comprise of or contain a membrane. Such contactors may share design features with cooling towers.

In some instances, a contactor may extract one or more chemical species from a feed stream. In some instances, a contactor may extract carbon dioxide from a feed stream. In some instances, a contactor may separate CO₂ from a feed stream and dissolve the CO₂ in an electrolyte solution. In some instances, a feed stream may be air. The uptake of CO₂ in a gas contactor may be enhanced by the presence of hydroxide ions generated within the electrochemical reduction system.

The contactor may comprise a cation exchange membrane stack. The contactor may comprise a bipolar membrane that selectively allows the transport of carbon containing species to the electrolyte. The contactor may also be used adjust the pH of electrolyte streams.

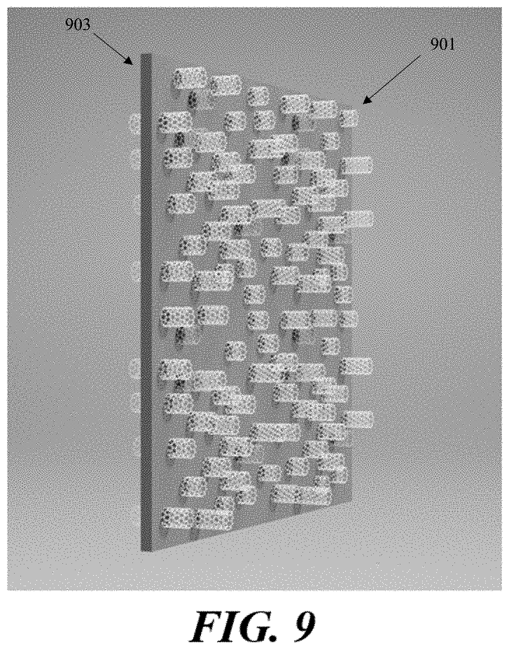

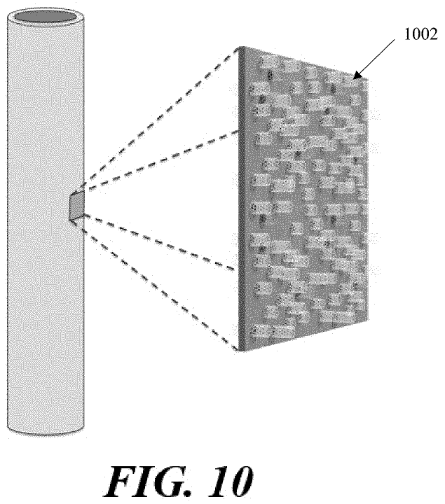

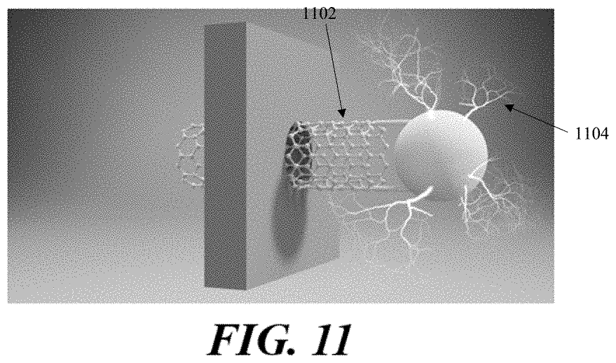

The contactor(s) may be a membrane contactor(s), random or structured gas-liquid contacting packing such as film fill or splash packing, packed falling film device(s) such as a cooling tower, fluidized beds, shower(s) of liquid(s) in contact with gas(es), and the like. In some embodiments, the contactors may consist of nanostructured carbon materials such as carbon nanotube membranes, shown in FIG. 9. In some embodiments, the contactor 903 may be a carbon nanotube membrane 901, shown in FIG. 9 and may have nanotubes 1002 functioning as pores, as shown in FIG. 10, and may have openings of the nanotubes 1102 functionalized with an adsorbing functional group 1104, such as an amine, shown in FIG. 11.

The present disclosure may provide reactor and separation systems that comprise micro- or nanostructured membranes. A micro- or nanostructured membrane may be utilized to perform a selective separation of one or more chemical species from a mixture comprising more than one chemical species. A micro- or nanostructured membrane may also provide additional utility in a chemical processing system including physically separating product streams and comprising a component of an electrical cathode or anode in an electrochemical system.

A micro- or nanostructured membrane may comprise one or more microscale or nanoscale materials features (e.g., including positive features, such as microscale or nanoscale structures, and/or negative features, such as microscale and nanoscale pores or microscale and nanoscale depressions). In some instances, a membrane may comprise carbon nanotubes, carbon nanospheres, carbon nano-onions, graphene-like materials, or pyrolyzed porous carbon materials (see FIG. 9 and FIG. 10). A membrane may comprise micro- or nanostructured material synthesized from non-carbon materials. A membrane may comprise carbon nanomaterials doped with other elements such as nitrogen, sulfur, and boron. A micro- or nanostructured material may be embedded, fixed, or otherwise bound to one or more other substrates or materials to construct a membrane. A micro- or nanostructured material embedded in a substrate or material may create pores within the structured membrane. The pores may permit the selective passage of certain chemical species. Other substrates or materials in the membrane may be selected for material properties including rigidity, strength, and/or electrical conductivity. Other substrates or materials in a micro- or nanostructured membrane may include polymers, e.g., polysulfones, metals, and ceramics. The microscale or nanoscale features may have a maximum dimension of at least about 0.4 nanometers (nm), 0.6 nm, 0.8 nm, 1 nm, 1.2 nm, 1.4 nm, 1.6 nm, 1.8 nm, 2.0 nm, 2.5 nm, 3.0 nm, 3.5 nm, 4.0 nm, 4.5 nm, 5.0 nm, 5.5 nm, 6.0 nm, 6.5 nm, 7.0 nm, 7.5 nm, 8.0 nm, 8.5 nm, 9.0 nm. 9.5 nm. 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 micrometer, 10 micrometers, 100 micrometers or larger. In some instances, the maximum dimension may be at most about 100 micrometers, 10 micrometers, 1 micrometer, 900 nm, 800 nm, 700 nm. 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9.5 nm, 9.0 nm, 8.5 nm, 8 nm, 7.5 nm, 7.0 nm, 6.5 nm, 6.0 nm, 5.5 nm, 5.0 nm, 4.5 nm, 4.0 nm, 3.5 nm, 3.0 nm, 2.5 nm, 2.0 nm, 1.8 nm, 1.6 nm, 1.4 nm, 1.2 nm, 1.0 nm, 0.8 nm, 0.6 nm, or 0.4 nm or less.

A micro- or nanostructured membrane may comprise a particular shape and/or structure depending upon its application. In some instances, a membrane may have a cylindrical structure (see FIG. 9 and FIG. 10), such as with a hollow fiber membrane format or have a substantially flat sheet structure. A membrane may partially or fully enclose a volume or void space. The surface area of a membrane disposed toward an enclosed or void space may be defined as a lumen side of the membrane. In some instances, mass transfer across a membrane may be driven by chemical potential, pressure difference, and/or temperature difference between a lumen side and a non-lumen side of a membrane. A membrane may further comprise additional structures such as frames or fittings that secure the membrane to other portions of the described systems.

A micro- or nanostructured membrane may be composed with micro- or nanomaterials embedded so as to create pores within the membrane. The micro- or nanomaterial may be chosen based upon a characteristic pore size that it may create. Without wanting to be bound by theory, a pore may be defined as a void space or volume within a solid material through which a liquid or gas molecule may flow or diffuse. A micro- or nanomaterial may have a characteristic length scale such as a diameter, (average) pore size, or layer spacing that is sufficient to permit the passage of chemical species through a void space in the material. In some instances, a characteristic length may be at least about 0.4 nanometers (nm), 0.6 nm, 0.8 nm, 1 nm, 1.2 nm, 1.4 nm, 1.6 nm, 1.8 nm, 2.0 nm, 2.5 nm, 3.0 nm, 4.0 nm, 5.0 nm or larger. In some instances, a characteristic length may be no more than about 5.0 nm, 4.0 nm, 3.0 nm, 2.5 nm, 2.0 nm, 1.8 nm, 1.6 nm, 1.4 nm, 1.2 nm, 1.0 nm, 0.8 nm, 0.6 nm, or about 0.4 nm or less. A pore may have a larger diameter than length. A pore may have a larger length than diameter. A pore may have a length to width ratio of about 1:10, 1:5, 1:2, 1:1, 2:1, 5:1, 10:1, 100:1, or about 1000:1. A pore may have a length to width ratio of at least about 1:10, 1:5, 1:2, 1:1, 2:1, 5:1, 10:1, 100:1, or about 1000:1. A pore may have a length to width ratio of no more than about 1000:1, 100:1, 10:1, 5:1, 2:1, 1:1, 1:2, 1:5, or about 1:10 or less. A pore may comprise a substantially straight path such as a carbon nanotube or the space between layers of horizontal graphene-like materials. A pore may have a diagonal, skewed, or tortuous path in some materials, such as meso- or nanoporous carbons.

A membrane may comprise a material with a characterized porous structure. Materials may include nanopores, mesopores, and micropores. In some instances, nanopores may be characterized as having an average diameter of about 2 nm or less. In some instances, mesopores may be characterized as having an average diameter of between about 2 nm and about 20 nm. In some instances, micropores may be characterized as having an average diameter of about 20 nm or more. A membrane may comprise structures with pore sizes across a range of pores sizes (e.g., nanopores and mesopores). A membrane may comprise structures with pores sizes from within a particular classification of pores sizes (e.g., only mesopores). A membrane may comprise pores (e.g., micropores or nanopores) with an average diameter of at least about 0.5 nm, 1 nm, 5 nm, 10 nm, 15 nm, 20 nm, 30 nm, 40 nm, 50 nm, 100 nm, 250 nm, 500 nm, 1 micron (μm), or at least about 5 μm. A membrane may comprise pores with an average diameter of no more than about 5 μm, 1 μm, 500 nm, 250 nm, 100 nm, 50 nm, 40 nm, 30 nm, 20 nm, 15 nm, 10 nm, 5 nm, 1 nm, 0.5 nm or less. A membrane comprising a micro- or nanostructured material may permit mass transport of one or more chemical species across the membrane. A membrane comprising a micro- or nanostructured material may be selective for particular species. In some instances, a membrane comprising micro- or nanostructured materials may selectively transfer CO₂ from a gas stream. In some instances, a membrane comprising micro- or nanostructured materials may selectively transfer gaseous ethylene or ethanol from a gas mixture. In some instances, a membrane comprising micro- or nanostructured materials may selectively transfer hydrocarbons from an aqueous liquid mixture. A membrane comprising a micro- or nanostructured material may transfer particular chemical species by diffusive or convective mass transport. In some instances, mass transfer may be enhanced by the application of an external force or field. In particular instances, mass transfer may be driven or enhanced by the application of a magnetic or electrical field. In other instances, mass transfer may be driven by a pressure gradient (e.g. pulling a vacuum on one side of the membrane). In some instances, the selectivity of a membrane can be reversed by reversing an applied field or force. In other instances, a membrane may have a unidirectional or invariant mass transfer selectivity. A voltage bias may be present in some cases due to the electrochemical reduction process being performed. A voltage bias may be used to change the selectivity of a membrane, for example from being alcohol-selective to being water-selective. Magnetic fields can be present when electrical fields are present, and can be used to affect the concentration of ions. A magnetic field can be affected to favorably increase availability of reactants or intermediates at a catalyst surface.

The micro- or nanostructured membrane may have an optimal or preferred operation temperature and operation pressure. In some instances, a system comprising a micro- or nanostructured membrane may be operated at an ambient pressure or temperature. In some instances, a system comprising a micro- or nanostructured membrane may be operated at an elevated pressure or under a vacuum or reduced pressure. A pressure gradient may be utilized to drive mass transfer across a membrane system. A micro- or nanostructured membrane may be utilized in a system with an operating temperature of about −30° C., −20° C., −10° C., 0° C., 5° C., 10° C., 15° C., 20° C., 25° C., 30° C., 35° C., 40° C., 50° C., 60° C., 70° C., or about 80° C. A micro- or nanostructured membrane may be utilized in a system with an operating temperature of at least about 31 30° C., −20° C., −10° C., 0° C., 5° C., 10° C., 15° C., 20° C., 25° C., 30° C., 35° C., 40° C., 50° C., 60° C., 70° C., or about 80° C. or more. A micro- or nanostructured membrane may be utilized in a system with an operating temperature of no more than about 80° C., 75° C., 70° C., 65° C., 60° C., 55° C., 50° C., 45° C., 40° C., 35° C., 30° C., 25° C., 20° C., 15° C., 10° C., 5° C., 0° C., −5° C., −10° C., −20° C., or about −30° C. or less.

A micro- or nanostructured membrane may be utilized in a system with an operating pressure of about 0 bar, 1 bar, 2 bar, 3 bar, 4, bar, 5 bar, 6 bar, 7 bar, 8 bar, 9 bar, 10 bar, 15 bar, 20 bar, 30 bar, 40 bar, 50 bar or more. A micro- or nanostructured membrane may be utilized in a system with an operating pressure of at least about 1 bar, 2 bar, 3 bar, 4, bar, 5 bar, 6 bar, 7 bar, 8 bar, 9 bar, 10 bar, 15 bar, 20 bar, 30 bar, 40 bar, 50 bar or more. A micro- or nanostructured membrane may be utilized in a system with an operating pressure of no more than about 50 bar, 40 bar, 30 bar, 20 bar, 15 bar, 10 bar, 9 bar, 8 bar, 7 bar, 6 bar, 5 bar, 4 bar, 3 bar, 2 bar, 1 bar or less.

A micro- or nanostructured membrane may be capable of permitting a particular flux of CO₂ across the membrane. A flux of CO₂ may be driven by a pressure gradient across the membrane. In some instances, a pressure gradient may be driven by a gas stream comprising CO₂ at a pressure elevated above ambient pressure. In other instances, a pressure gradient may exist by pulling a vacuum on one side of the membrane, e.g. the lumen side. A micro- or nanostructured membrane may permit a CO₂ flux of about 0.1 kilogram gas/m² of membrane/hr (kg/m²/hr), 0.5 kg/m²/hr, 1 kg/m²/hr, 2 kg/m²/hr, 3 kg/m²/hr, 4 kg/m²/hr, 5 kg/m²/hr, 6 kg/m²/hr, 7 kg/m²/hr, 8 kg/m²/hr, 9 kg/m²/hr, or about 10 kg/m²/hr. A micro- or nanostructured membrane may permit a CO₂ flux of at least about 0.1 kg/m²/hr, 0.5 kg/m²/hr, 1 kg/m²/hr, 2 kg/m²/hr, 3 kg/m²/hr, 4 kg/m²/hr, 5 kg/m²/hr, 6 kg/m²/hr, 7 kg/m²/hr, 8 kg/m²/hr, 9 kg/m²/hr, or at least about 10 kg/m²/hr. A micro- or nanostructured membrane may permit a CO₂ flux of no more than about 10 kg/m²/hr, 9 kg/m²/hr, 8 kg/m²/hr, 7 kg/m²/hr, 6 kg/m²/hr, 5 kg/m²/hr, 4 kg/m²/hr, 3 kg/m²/hr, 2 kg/m²/hr, 1 kg/m²/hr, 0.5 kg/m²/hr, or about 0.1 kg/m²/hr or less.

A micro- or nanostructured membrane may be capable of permitting a particular flux of hydrocarbons across the membrane. A flux of hydrocarbons may be driven by a pressure gradient across the membrane. In some instances, a pressure gradient may be driven by a gas or liquid stream comprising hydrocarbons at a pressure elevated above ambient pressure. In other instances, a pressure gradient may exist by pulling a vacuum on one side of the membrane, e.g., the lumen side. A micro- or nanostructured membrane may permit a hydrocarbon flux of about 0.1 kilogram hydrocarbon/m² of membrane/hr (kg/m²/hr), 0.5 kg/m²/hr, 1 kg/m²/hr, 2 kg/m²/hr, 3 kg/m²/hr, 4 kg/m²/hr, 5 kg/m²/hr, 6 kg/m²/hr, 7 kg/m²/hr, 8 kg/m²/hr, 9 kg/m²/hr, or about 10 kg/m²/hr. A micro- or nanostructured membrane may permit a hydrocarbon flux of at least about 0.1 kilogram kg/m²/hr, 0.5 kg/m²/hr, 1 kg/m²/hr, 2 kg/m²/hr, 3 kg/m²/hr, 4 kg/m²/hr, 5 kg/m²/hr, 6 kg/m²/hr, 7 kg/m²/hr, 8 kg/m²/hr, 9 kg/m²/hr, or at least about 10 kg/m²/hr. A micro- or nanostructured membrane may permit a hydrocarbon flux of no more than about 10 kg/m²/hr, 9 kg/m²/hr, 8 kg/m²/hr, 7 kg/m²/hr, 6 kg/m²/hr, 5 kg/m²/hr, 4 kg/m²/hr, 3 kg/m²/hr, 2 kg/m²/hr, 1 kg/m²/hr, 0.5 kg/m²/hr, or about 0.1 kg/m²/hr or less.

A membrane with an enhanced selectivity for one or more chemical species may enhance the chemical conversion rate or phase equilibrium of a conversion system. Without wanting to be bound to theory, selective enrichment for one or more chemical species within the void or pore space of the micro- or nanostructured component of a membrane may increase the volumetric concentration of the one or more chemical species within the void or pore space. In some instances, a kinetic rate enhancement or shift in phase equilibrium for a particular chemical reaction may be driven by one or more chemical species having higher volumetric concentrations within the membrane than may be predicted by their bulk phase concentrations on either side of the membrane. In a particular instance, the selective mass transfer of one or more chemical species through a membrane may cause an increased concentration of the one or more chemical species in a boundary layer adjacent to the surface of the membrane. An increase in the boundary layer concentration of the one or more chemical species may increase the availability of one or more chemical species to a catalyst deposited at the surface of the membrane. In another instance, an adsorbent with affinity for a target species may be part of the membrane surface or pore entrances and may enhance the concentration of the target species at the surface to facilitate selective transport, e.g., amines. In another instance, a catalyst may be deposited within the void or pore space of a micro- or nanostructured material within a membrane, allowing direct transfer of an increased mass transfer of one or more chemical species to the catalyst by bulk flow.

The mass transfer selectivity of a membrane for one or more chemical species may cause a measurable enhancement of the rate of reaction for one or more chemical reactions in a chemical conversion system that comprises such a membrane. In some instances, the rate of reaction for one or more chemical reactions may increase by at least about 5%, 10%, 20%, 30%, 40%, 50%, 75%, 100%, 150%, 200%, 500%, or about 1000% or more. In some instances, the rate of reaction for one or more chemical reactions may be higher than may be predicted by the use of measured reactant concentrations due to other synergistic effects such as electric field enhancement of catalyst activity. In some instances, the mass transfer selectivity of a membrane for one or more chemical species may cause a measurable reduction in the rate of reaction for one or more chemical unwanted reactions (e.g., side reactions, degradation reactions) in a chemical conversion system that comprises such a membrane. In some instances, the rate of reaction for one or more unwanted chemical reactions may decrease by at least about 5%, 10%, 20%, 30%, 40%, 50%, 75%, 100%, 150%, 200%, 500%, or about 1000% or more.

A membrane comprising a micro- or nanostructured material may further comprise one or more catalyst materials. A catalyst material may be attached, bonded, deposited, or functionalized to the surface of a micro- or nanostructured material. In some instances, a catalyst may be located on a surface of a membrane. A catalyst may be localized in particular areas of a membrane or on particular areas of a micro- or nanostructured material to control where a catalyzed chemical reaction may occur. A catalyst may be located within a pore or pore-like structure in a membrane. A chemical reaction catalyzed by a catalyst may occur on a particular area of the membrane or within the pore or pore-like space of the membrane. A catalyst may comprise a metal atom, metal complex, or metal particle. A catalyst may comprise a metal such as titanium, vanadium, chromium, manganese, iron, cobalt, nickel, copper, zinc, aluminum, silicon, yttrium, zirconium, niobium, molybdenum, ruthenium, rhodium, palladium, silver, cadmium, indium, tin, antimony, tantalum, tungsten, osmium, platinum, gold, mercury, or lead. In some instances, a doped carbon nanomaterial may comprise a catalyst. In a particular instance, N-doped carbon nanotubes may comprise a catalyst. In another instance, carbon nanotubes with electrodeposited platinum, nickel, or copper nanoparticles may comprise a catalyst (see FIG. 11). A membrane may comprise more than one catalyst. In some instances, one or more catalysts may be deposited on one or more areas or surfaces of a membrane, and one or more differing catalysts may be deposited on one or more differing areas or surfaces of a membrane. A membrane may be capable of catalyzing one or more chemical reactions when mass transfer occurs in a particular direction across the membrane, and may be capable of catalyzing one or more differing chemical reactions when mass transfer occurs in a differing direction across the membrane.

An electrochemical reduction process utilizing a micro- or nanostructured catalyst membrane may utilize methods or components to minimize catalyst poisoning. A micro- or nanostructured membrane comprising a catalyst may be refreshed or regenerated to mitigate the impact of catalyst poisoning and the deposition of other unwanted species. In some instances, a membrane may be removed from an electrochemical reduction system for catalyst regeneration. In other instances, a membrane may be flushed with acid to dissolve or remove catalyst particles, followed thereafter by deposition of new catalyst particles on the membrane surface or nanoparticle surface.

A membrane comprising a micro- or nanostructured material may have enhanced electrical properties. In some aspects, the membrane may be conductive, due to the electrical properties of the micro- or nanostructured materials. In some instances, a membrane may be semiconducting (e.g., carbon nanotubes of a particular chirality). A membrane may be configured to act as an electrode in an electrochemical system. A membrane may allow an electrical current to be conveyed to one or more catalysts associated with it. An electrical current may enhance the reactivity of a catalyst for particular catalyzed chemical reactions. In some instances, the selective mass transfer of particular chemical species across a micro- or nanostructured membrane may increase the current density achieved at the membrane electrode.

A membrane comprising a micro- or nanostructured material may be utilized for various purposes. In some instances, a membrane may permit mass transfer of a chemical species from a first gas mixture into a second gas mixture. In some instances, a membrane may permit mass transfer of a chemical species from a gas phase into a liquid phase. In some instances, a membrane may permit mass transfer of a chemical species from a first liquid mixture into a second liquid mixture. In some instances, a membrane may permit mass transfer of a chemical species to a catalytic site where a chemical reaction may occur. In some instances, a membrane may be utilized to perform both chemical separations and catalysis. In some instances, a membrane may be cycled between separation and catalysis by the directional application of electric fields or other fields or forces. In other instances, a membrane may be capable of simultaneously catalyzing and performing a chemical separation.

In some instances, heat exchangers and cooling or heating systems may be used to maintain desired temperatures in the various reservoirs, stack, or other unit elements. In some instances, the contactor unit, where the chemical reduction happens, may comprise a micro- or nanostructured membrane. The micro- or nanostructured membrane may comprise one or more catalysts. In other instances, a catalysis process may comprise a conventional electrochemical “stack”, comprising an anode and cathode within the same housing. In some instances, an ion exchange membrane may be used. In some instances, various catalytic membranes may be used, or otherwise achieve the desired reduction of CO₂ by other methods of reduction. Oxygen or other oxidized species may also be produced by such a process and released to the atmosphere or directed to beneficial use.

Provided are example systems and methods for capturing and reducing carbon dioxide, captured from air, using an electrolyte solution.

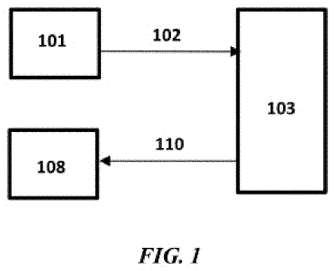

Various embodiments of an integrated CO₂ capture process that results in the dissolution of CO₂ into an electrolyte may be conceived. In some instances, as depicted in FIG. 1, an electrolyte stream 102, containing an electrolyte solution for use in an electrochemical CO₂ reduction process, may flow from a reservoir 101 to a contactor 103 where it is contacted with a CO₂ containing gas. The CO₂ containing gas may be air from the atmosphere. In some instances, the pH of the electrolyte stream 102 may be controlled such that CO₂ is absorbed from the CO₂ containing gas into the electrolyte solution. In some instances, the temperature of the electrolyte stream 102 may be controlled such that CO₂ is absorbed from the CO₂ containing gas into the electrolyte solution. After leaving the contactor 103, the electrolyte stream 110 returns to a second electrolyte reservoir 108. In some instances, the CO₂ containing gas also contains water which may also be absorbed by the electrolyte stream. The temperature of the electrolyte stream 102 or any other component of the contactor 103 may be controlled particularly to facilitate the capture of water. Water may be a reactant in the conversion of CO₂ into hydrocarbons, so water may be supplied to the reaction from different sources, such as by capture with CO₂ from the air and/or from another source. Decreasing the temperature of the absorbing fluid below the dew point of the CO₂-containing gas source (e.g., air) can result in the simultaneous capture of water due to condensation from the air.

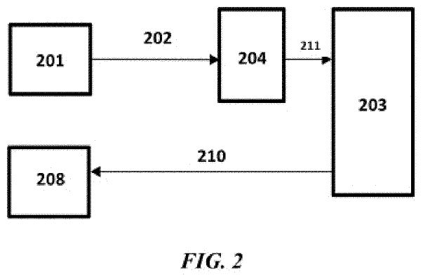

In another example, depicted in FIG. 2, an electrolyte stream 202, containing an electrolyte solution for use in an electrochemical CO₂ reduction process, may be directed from an electrolyte reservoir 201 to a pH controlling unit 204. The pH of the electrolyte stream 202 may be adjusted to facilitate CO₂ adsorption. The pH controlling unit 204 may increase the pH of the electrolyte stream 202 to between 10-15. For example, stream 211 may have a pH of about 10, 11, 12, 13, 14, or 15 after passing the pH controlling unit 204. In some instances, the electrolyte stream 211 may enter a contactor 203 where it is contacted with a CO₂ containing fluid. In some instances, the CO₂ containing fluid is the atmospheric air. The adsorption of CO₂ in the contactor 203 may cause the pH of the electrolyte to be reduced to between 7-9. For example, stream 210 may have a pH of about 7, 8, or 9 after adsorption of CO₂ in the contractor 203. After leaving the contactor 203, the electrolyte stream 210 may continue to a second electrolyte reservoir 208. In some instances, the CO₂ containing gas also contains water which may also be absorbed. In some instances, the temperature of the electrolyte stream(s) or any other component of the contactor 203 may be controlled particularly to facilitate the capture of water.

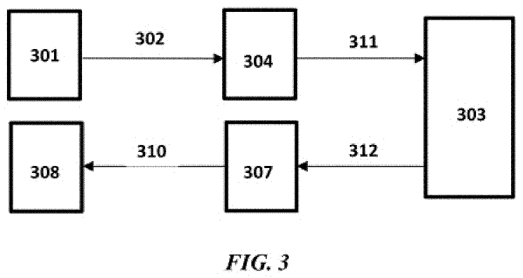

In another example, depicted in FIG. 3, an electrolyte stream 302, containing an electrolyte solution for use in an electrochemical CO₂ reduction process, may be directed from an electrolyte reservoir 301 to a pH controlling unit 304. The pH of the electrolyte stream 302 may be adjusted to facilitate CO₂ adsorption. The pH controlling unit 304 may adjust the pH of the electrolyte stream to between 10-15. For example, stream 311 may have a pH of about 10, 11, 12, 13, 14, or 15 after passing the pH controlling unit 304. In some instances, the electrolyte stream 311 may enter a contactor 303 where it is contacted with a CO₂ containing fluid. In some instances, the CO₂ containing fluid is the atmosphere. After leaving the contactor 303, the electrolyte stream 312 may continue to a second pH controlling unit 307. The pH of the electrolyte stream 312 may be adjusted to facilitate CO₂ reduction. The second pH controlling unit 307 may adjust the pH of the electrolyte stream to between 7-10. For example, stream 310 may have a pH of about 7, 8, 9, or 10 after adsorption of CO₂ in the contractor 307. The electrolyte stream 310 may continue to a second electrolyte reservoir 308. In some instances, the CO₂ containing gas also contains water which may also be absorbed. In some instances, the temperature of the electrolyte stream or any other component of the contactor 303 may be controlled particularly to facilitate the capture of water.

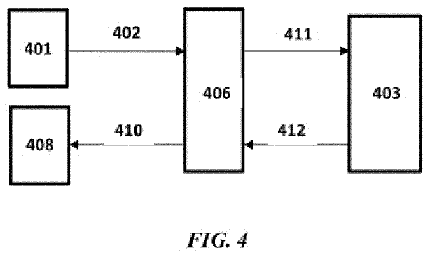

In another example, depicted in FIG. 4, an electrolyte stream 402, containing an electrolyte solution for use in an electrochemical CO₂ reduction process, may be directed from an electrolyte reservoir 401 to a pH controlling unit 406. The pH of the electrolyte stream 402 may be adjusted to facilitate CO₂ adsorption. The pH controlling unit 406 may adjust the pH of the electrolyte stream to between 10-15. For example, stream 411 may have a pH of about 10, 11, 12, 13, 14, or 15 after passing the pH controlling unit 406. In some instances, the electrolyte stream 411 may enter a contactor 403 where it is contacted with a CO₂ containing fluid. In some instances, the CO₂ containing fluid is the atmosphere. After leaving the contactor 403, the electrolyte stream 412 may reenter the pH controlling unit 406. The pH of the electrolyte stream 412 may be adjusted to facilitate CO₂ reduction. The pH controlling unit 406 may adjust the pH of the electrolyte stream to between 7-10. For example, stream 410 may have a pH of about 7, 8, 9, or 10 after passing the pH controlling unit 406. The electrolyte stream 410 may continue to a second electrolyte reservoir 408. In some instances, the CO₂ containing gas also contains water which may also be absorbed. In some instances, the temperature of the electrolyte stream or any other component of the contactor 403 may be controlled particularly to facilitate the capture of water. The pH controlling unit 406 may be a bipolar membrane stack that may cause one input stream 402 to raise in pH and the other input stream 412 to lower in pH. For example, the pH of stream 402 may be lower than the pH of stream 411, and the pH of stream 412 may be higher than the pH of stream 410. The pH controlling unit 406 may be an electrochemical stack that may reduce CO₂ and hydrogen (H₂) while producing oxygen, such that the stack may be operated to raise the pH of stream 402 and lower the pH of stream 412. This electrochemical stack 406 may not be optimized for CO₂ reduction, but rather for pH adjustment.

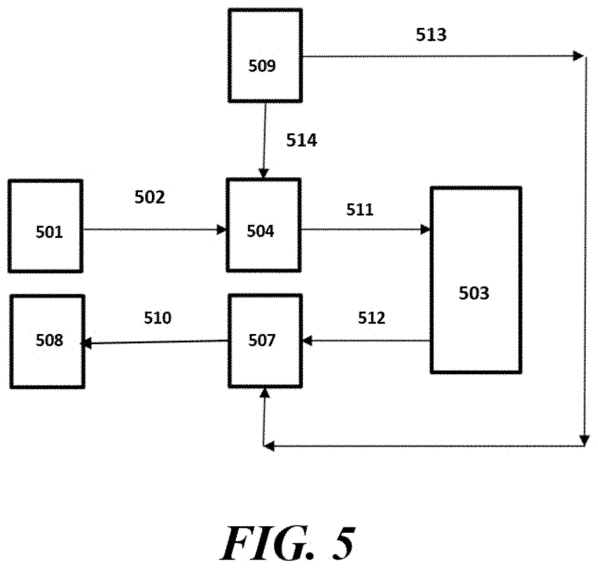

In another example, depicted in FIG. 5, an electrolyte stream 502, containing an electrolyte solution for use in an electrochemical CO₂ reduction process, may be directed from an electrolyte reservoir 501 to a pH controlling unit 504. The pH of the electrolyte stream 502 may be adjusted to facilitate CO₂ adsorption. In some instances, after passing the pH controlling unit 504, the electrolyte stream 511 may enter a contactor 503 where it is contacted with a CO₂ containing fluid. In some instances, the CO₂ containing fluid is the atmosphere. After leaving the contactor 503, the electrolyte stream 512 may continue to a second pH controlling unit 507. The pH of the electrolyte stream 512 may be adjusted to facilitate CO₂ reduction. After the passing the pH controlling unit 507, the electrolyte stream 510 may continue to a second electrolyte reservoir 508. A separate method of creating acid and base streams 509 may be used to create acid 513 and base 514 which are used to adjust pH in the pH controlling unit 507 and 504, respectively. In some instances, the CO₂ containing gas also contains water which may also be absorbed. In some instances, the temperature of the electrolyte stream or any other component of the contactor 503 may be controlled particularly to facilitate the capture of water.

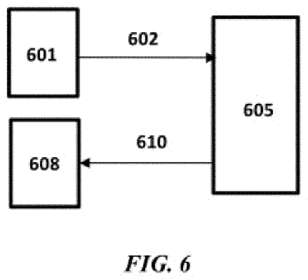

In another example, depicted in FIG. 6, an electrolyte stream 602, containing an electrolyte solution for use in an electrochemical CO₂ reduction process, may flow from a reservoir 601 to a contactor 605 where it is contacted with a CO₂ containing gas. The CO₂ containing gas may be the atmosphere. In some instances, the pH of the electrolyte stream 602 may be controlled such that CO₂ is absorbed from the CO₂ containing gas into the electrolyte solution. In some instances, the temperature of the electrolyte stream 602 may be controlled such that CO₂ is absorbed from the CO₂ containing gas into the electrolyte solution. The contactor 605 may include an adsorbent to facilitate the adsorption of CO₂ from the CO₂ containing gas. In some instances, the adsorbent is a solid substrate for reactive chemical adsorbents. One example of such an adsorbent is polystyrene beads functionalized with amines. Another example is activated or nanostructured carbon materials such as carbon nanotubes, Buckminster fullerene, or graphene. After leaving the contactor 605, the electrolyte stream 610 returns to a second electrolyte reservoir 608. In some instances, the CO₂ containing gas also contains water which may also be absorbed. The temperature of the electrolyte stream 602 or any other component of the contactor 605 may be controlled particularly to facilitate the capture of water.

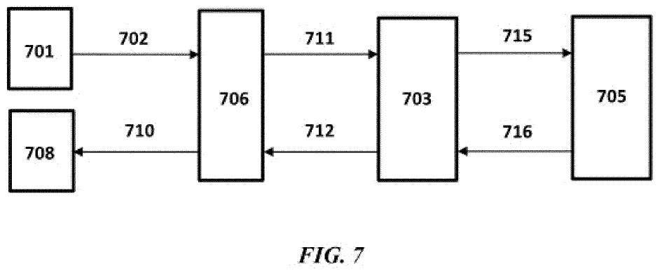

In another example, depicted in FIG. 7, an electrolyte stream 702, containing an electrolyte solution for use in an electrochemical CO₂ reduction process, may be directed from an electrolyte reservoir 701 to a pH controlling unit 706. The pH of the electrolyte stream 702 may be adjusted to facilitate CO₂ adsorption. The pH controlling unit 706 may adjust the pH of the electrolyte stream to between 10-15. For example, stream 711 may have a pH of about 10, 11, 12, 13, 14, or 15 after passing the pH controlling unit 706. In some instances, the pH-adjusted electrolyte stream 711 may enter a contactor 703 and may be contacted with a liquid adsorbent for CO₂. The liquid adsorbent may be an aqueous hydroxide solution, an amine solution, an ionic liquid, or any other liquid adsorbent. The lean CO₂ adsorbing liquid 715 may leave the contactor 703 and be directed to a contactor 705 where it may be contacted with a CO₂ containing fluid. The CO₂ containing fluid may be the atmosphere. The CO₂ rich adsorbing liquid 716 may leave the contactor 705 and be directed to the contactor 703 where it may be contacted with the electrolyte stream 711. The CO₂ enriched electrolyte stream 712 may leave the contactor 703 and be directed to a pH controlling unit 706. The pH of the electrolyte stream 712 may be adjusted to facilitate CO₂ reduction. The pH controlling unit 706 may adjust the pH of the electrolyte stream to between 7-10. For example, stream 710 may have a pH of about 7, 8, 9, or 10 after passing the pH controlling unit 706. The pH-adjusted electrolyte stream 710 may continue to a second electrolyte reservoir 708. In some instances, the CO₂ containing gas also contains water which may also be absorbed. In some instances, the temperature of the electrolyte stream or any other component of the contactor 703 may be controlled particularly to facilitate the capture of water. The pH controlling unit 706 may be a bipolar membrane stack that may cause one input stream 702 to raise in pH and the other input stream 712 to lower in pH. For example, the pH of stream 702 may be lower than the pH of stream 711, and the pH of stream 712 may be higher than the pH of stream 710. The pH controlling unit 706 may be an electrochemical stack that may reduce CO₂ and hydrogen (H₂) while producing oxygen, such that the stack may be operated to raise the pH of stream 702 and lower the pH of stream 712. This electrochemical stack 406 may not be optimized for CO₂ reduction, but rather for pH adjustment.

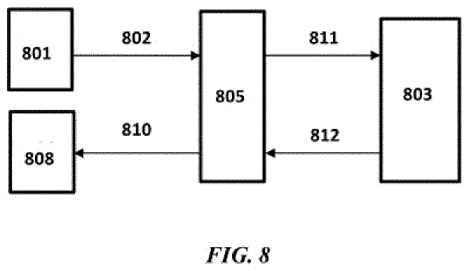

In another example, depicted in FIG. 8, an electrolyte stream 802, containing an electrolyte solution for use in an electrochemical CO₂ reduction process, may be directed from an electrolyte reservoir 801 to a contactor 805 where it may be contacted with a liquid adsorbent for CO₂. The liquid adsorbent may be an aqueous hydroxide solution, an amine solution, an ionic liquid, or any other liquid adsorbent. The lean CO₂ adsorbing liquid 811 may leave the contactor 805 and be directed to a contactor 803 where it may be contacted with a CO₂ containing fluid. The CO₂ containing fluid may be the atmosphere. The CO₂ rich adsorbing liquid 812 may leave the contactor 803 and be directed to the contactor 805 where it may be contacted with the electrolyte stream 802.

The CO₂ enriched electrolyte stream 810 may leave the contactor 805 and continue to a second electrolyte reservoir 808. In some instances, the CO₂ containing gas also contains water which may also be absorbed. In some instances, the temperature of the electrolyte stream or any other component of the contactor 805 may be controlled particularly to facilitate the capture of water. The contactor 805 may be a bipolar membrane stack containing an anion exchange membrane, cation exchange membrane stack, or both. The contactor 805 may also have a bipolar membrane that may selectively allow the transport of carbon-containing species from the CO₂ rich adsorbing liquid 812 to the electrolyte stream 802. The contactor 805 may also adjust the pH of input streams 802 and 812.

### Computer Systems

The present disclosure provides computer systems that are programmed to implement methods of the disclosure. FIG. 12 shows a computer control system 1201 that is programmed or otherwise configured to control a chemical reduction system or a process within a chemical reduction system (e.g., controlling and balancing the pH of an electrolyte stream). The computer control system 1201 can regulate various aspects of the methods of the present disclosure, such as, for example, methods of producing a reduced carbon product or monitoring for potentially hazardous operating conditions. The computer control system 1201 can be implemented on an electronic device of a user or a computer system that is remotely located with respect to the electronic device. The electronic device can be a mobile electronic device.

The computer system 1201 includes a central processing unit (CPU, also “processor” and “computer processor” herein) 1205, which can be a single core or multi core processor, or a plurality of processors for parallel processing. The computer system 1201 also includes memory or memory location 1210 (e.g., random-access memory, read-only memory, flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an internet and/or extranet, or an intranet and/or extranet that is in communication with the Internet. The network 1230 in some cases is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, and writeback.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and saved programs. The storage unit 1215 can store user data, e.g., user preferences and user programs. The computer system 1201 in some cases can include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user (e.g., a user monitoring the pH and temperature of an electrolyte stream). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein can be implemented by way of machine (e.g., computer processor) executable code stored on an electronic storage location of the computer system 1201, such as, for example, on the memory 1210 or electronic storage unit 1215. The machine executable or machine readable code can be provided in the form of software. During use, the code can be executed by the processor 1205. In some cases, the code can be retrieved from the storage unit 1215 and stored on the memory 1210 for ready access by the processor 1205. In some situations, the electronic storage unit 1215 can be precluded, and machine-executable instructions are stored on memory 1210.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display 1235 that comprises a user interface (UI) 1240 for providing, for example, the pH and/or temperature of electrolyte streams. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1205. The algorithm can, for example, regulate the flow rate of a gas stream comprising CO₂ through a contactor to optimize the pH or bicarbonate concentration of an electrolyte solution. As another example, the algorithm can regulate the electric field applied to a micro- or nanostructured membrane to control the selectivity of the membrane for a particular chemical species.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for integrated direct air capture of carbon dioxide (CO₂) for aqueous electrochemical reduction of CO₂, comprising:
(a) providing a housing comprising an electrochemical reduction system comprising an electrolyte solution, an anode, and a cathode;
(b) directing an input air stream to said housing to bring said input air stream in contact with said electrolyte solution in said housing, wherein said input air stream comprises CO₂, thereby capturing said CO₂ from said input air stream into said electrolyte solution to generate a first bicarbonate ion; and
(c) while a voltage is applied between said cathode and said anode, reducing said first bicarbonate ion to generate a carbon product,
wherein said electrochemical reduction system is used to adjust a pH of said electrolyte solution to facilitate capture of said CO₂ into said electrolyte solution or facilitate CO₂ reduction, wherein generation of said carbon product in (c):
(1) produces a hydroxide ion, wherein said hydroxide ion shifts a second bicarbonate ion to a carbonate ion, and
(2) regenerates carbonate ion or bicarbonate ion to maintain (i) an optimal pH for reducing additional CO₂, or (ii) an optimal concentration of carbonate ion or bicarbonate ion for reducing additional CO₂.

2. The method of claim 1, wherein said capture of said CO₂ comprises absorption by said electrolyte solution.

3. The method of claim 1, wherein said input air stream has a CO₂ concentration of at most 500 parts per million (ppm).

4. The method of claim 1, wherein said input air stream comprises H₂O, and wherein subsequent to (b), at least a subset of said H₂O is absorbed by said electrolyte solution.

5. The method of claim 4, further comprising controlling a temperature or range thereof of said electrolyte solution to facilitate capture of said H₂O.

6. The method of claim 1, wherein said reducing in (c) is in the absence of an independent hydrogen feed to said electrolyte solution.

7. The method of claim 1, wherein said housing comprises a contactor, and wherein in (b), said input air stream and said electrolyte solution are contacted at said contactor.

8. The method of claim 1, further comprising directing said electrolyte solution to an electrolyte reservoir.

9. The method of claim 7, wherein said contactor comprises an adsorbent to facilitate capture of said CO₂ from said input air stream into said electrolyte solution.

10. The method of claim 9, wherein said adsorbent comprises a solid substrate comprising reactive chemical adsorbents selected from the group consisting of polystyrene bead functionalized with amines, carbon nanotubes (CNTs), Buckminster fullerene, and graphene.

11. The method of claim 7, wherein said contactor comprises one or more members selected from the group consisting of: a membrane contactor, random or structured gas-liquid contacting packing, film fill, splash packing, packed falling film device, cooling tower, fluidized bed, liquid shower in contact with gases, and nanostructured or activated carbon material.

12. The method of claim 11, wherein said membrane contactor comprises a carbon nanotube membrane, wherein a plurality of nanotubes of said carbon nanotube membrane function as pores and wherein a plurality of openings of said plurality of nanotubes are functionalized with adsorbing functional groups.

13. (canceled)

14. The method of claim 1, wherein said pH controlling unit adjusts or maintains a pH range of said electrolyte solution to between 9-15 or between 7-10.

15. (canceled)

16. The method of claim 1, wherein said pH controlling unit comprises (i) a bipolar membrane stack, (ii) an electrochemical stack configured to reduce said CO₂ and hydrogen while generating oxygen, such that a pH of said electrolyte solution increases when flowed through said pH controlling unit in a first direction and said pH of said electrolyte solution decrease when flowed through said pH controlling unit in a second direction different from said first direction, or (iii) an acid and base supplying unit, wherein said acid and base supplying unit is configured to (1) supply an acidic solution to said electrolyte solution subsequent to said contacting of said air stream and said electrolyte solution to decrease a pH or range thereof of said electrolyte solution and (2) supply a basic solution to said electrolyte solution prior to said contacting of said air stream and said electrolyte solution to increase a pH or range thereof of said electrolyte solution.

17. The method of claim 1, further comprising, prior to (b), contacting a first electrolyte solution with a solution comprising one or more members selected from the group consisting of: an aqueous hydroxide solution, an amine solution, and an ionic liquid to output said electrolyte solution.

18. The method of claim 17, wherein, subsequent to (c), said electrolyte solution is contacted with said first electrolyte solution.

19. (canceled)

20. The method of claim 17, wherein said first electrolyte solution and said solution are contacted at a bipolar membrane stack.

21. The method of claim 1, wherein said electrochemical reduction system comprises a membrane.

22. The method of claim 21, wherein said membrane comprises a plurality of pores.

23. The method of claim 21, wherein said membrane comprises a catalyst.

24. (canceled)

25. (canceled)

26. (canceled)

27. The method of claim 1, wherein a pH controlling unit is separate from said housing.

28. The method of claim 1, wherein said housing comprises compartments.
